(19) United States
(12) Patent Application Publication
(10) Pub. No.: US 2018/0295336 A1
(43) Pub. Date: Oct. 11, 2018

(54) IMAGING SYSTEM FOR SENSING 3D image

(71) Applicant: Himax Imaging Limited, Tainan City (TW)

(72) Inventor: Po-Chang Chen, Tainan City (TW)

(21) Appl. No.: 15/484,141

(22) Filed: Apr. 11, 2017

(51) Int. Cl. H04N 13/02; H04N 5/33; G02B 3/00; G02B 5/20

(52) U.S. Cl. CPC H04N 13/0228; H04N 13/0253; G02B 5/208; G02B 3/0006; G02B 5/201; H04N 5/332

(57) ABSTRACT

The present invention provides an imaging system, comprising: a lens, an image sensor, and a dual-mode optical filter. The lens is utilized for receiving a visible light and an IR light. The image sensor comprises: a pixel array, a micro-lens array, and an IR filter array. The pixel array has a first group of pixels and a second group of pixels. The IR filter array comprises a group of IR blocking filters for blocking the IR light to prevent the IR light from reaching the second group of pixels. The dual-mode optical filter is disposed between the lens and the image sensor, and has a dual window transmission spectrum comprising: a first pass band to pass the IR light; and a second pass band to pass the visible light both onto the image sensor.

### BACKGROUND OF THE INVENTION

### 1. Field of the Invention

The present invention relates to an imaging system, and more particularly, to an imaging system for sensing a 3D image and capable of making the pixel array of the image sensor to independently sense the visible light and the IR light, and sense the visible light with highly reduced IR contamination

### 2. Description of the Prior Art

Please refer to FIG. 1. FIG. 1 is a simplified diagram of a conventional imaging system 10 for sensing a 3D image in the prior art. As shown in FIG. 1, the conventional imaging system 10 comprises a color sensor 12, an IR sensor 14, and an IR light emitter 16. The color sensor 12 is for sensing a 2D color image. The IR sensor 14 is for sensing a projected IR pattern from the light emitter 16 (reflected via an object 20) to retrieve depth information. However, the arrangement possesses a spatial misalignment between the 2D color image and the IR image (shown in FIG. 1) which need post-processing for rectification. Besides, it potentially increases the module size as well as cost due to the three major elements (the color sensor 12, the IR sensor 14, and the IR light emitter 16) compared with the two-element solutions, such as one RGB-IR sensor plus a IR light emitter.

Please refer to FIG. 2. FIG. 2 shows charts illustrating transmission spectrums of the elements in an image sensing system with a RGB-IR sensor in US patent publication No. 20150200220. As shown in FIG. 2, the IR blocking filter can be viewed as an IR-cut filters, which is not able to effectively block the light out of the desired visible band but permit a considerable amount of IR light passing through onto the visible pixels of the RGB-IR sensor, which leads to non-negligible IR contaminant. The IR contamination would degrade color image quality (IQ) including color aliasing or fade-out, or decrease the SNR if using local IR-pixel data for color correction (for example, local RGB data−local IR data, signals reduced but noises increased).

Please refer to FIG. 3. FIG. 3 shows charts illustrating transmission spectrums of the elements in an image sensing system with a RGB-IR sensor by combining US patent publication No. 20150200220 with U.S. Pat. No. 8,408,821. As shown in FIG. 3, even a dual-mode optical filter of U.S. Pat. No. 8,408,821 is added to the image sensing system of US patent publication No. 20150200220, there is still an observable IR contamination, and the IR contamination would still degrade the color IQ.

### SUMMARY OF THE INVENTION

It is therefore one of the objectives of the disclosure to provide an imaging system for sensing a 3D image and capable of making the pixel array of the image sensor (e.g. the RGB-IR sensor) to independently sense the visible light (e.g. RGB) and the IR light, and sense the visible light with highly reduced IR contamination to improve the color image quality (IQ), so as to solve the problem mentioned above.

In accordance with an embodiment of the present invention, an imaging system for sensing a 3D image is disclosed. The imaging system comprises: a lens, an image sensor, and a dual-mode optical filter. The lens is utilized for receiving a visible light and an IR light. The image sensor comprises: a pixel array, a micro-lens array, and an IR filter array. The pixel array has a first group of pixels and a second group of pixels. The micro-lens array is utilized for focusing the visible light and the IR light onto associated pixels. The IR filter array comprises a group of IR blocking filters for blocking the IR light to prevent the IR light from reaching the second group of pixels. The dual-mode optical filter is disposed between the lens and the image sensor, and has a dual window transmission spectrum comprising: a first pass band to pass the IR light; and a second pass band to pass the visible light both onto the image sensor.

Briefly summarized, the imaging system disclosed by the present invention is capable of making the visible pixels to sense the visible light (e.g. RGB) with highly reduced IR contamination, and the IR pixels will only sense the IR light. In other words, the imaging system disclosed by the present invention is capable of making the pixel array of the image sensor (e.g. the RGB-IR sensor) to independently sense the visible light (e.g. RGB) and the IR light, and sense the visible light with highly reduced IR contamination to improve the color image quality (IQ).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified diagram of a conventional imaging system 10 for sensing a 3D image in the prior art.

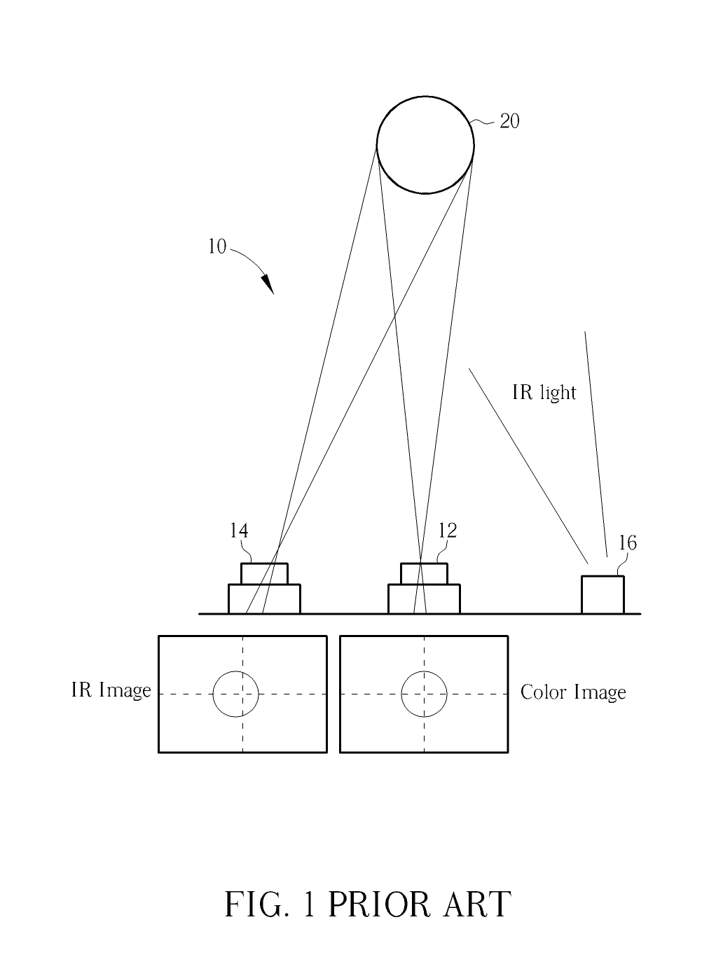

FIG. 2 shows charts illustrating transmission spectrums of the elements in an image sensing system with a RGB-IR sensor in US patent publication No. 20150200220.

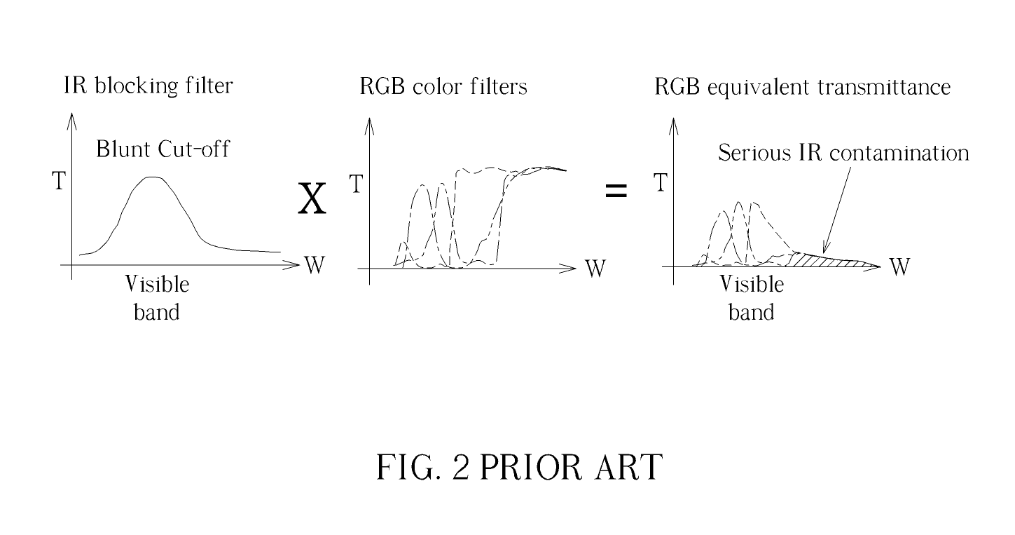

FIG. 3 shows charts illustrating transmission spectrums of the elements in an image sensing system with a RGB-IR sensor by combining US patent publication No. 20150200220 with U.S. Pat. No. 8,408,821.

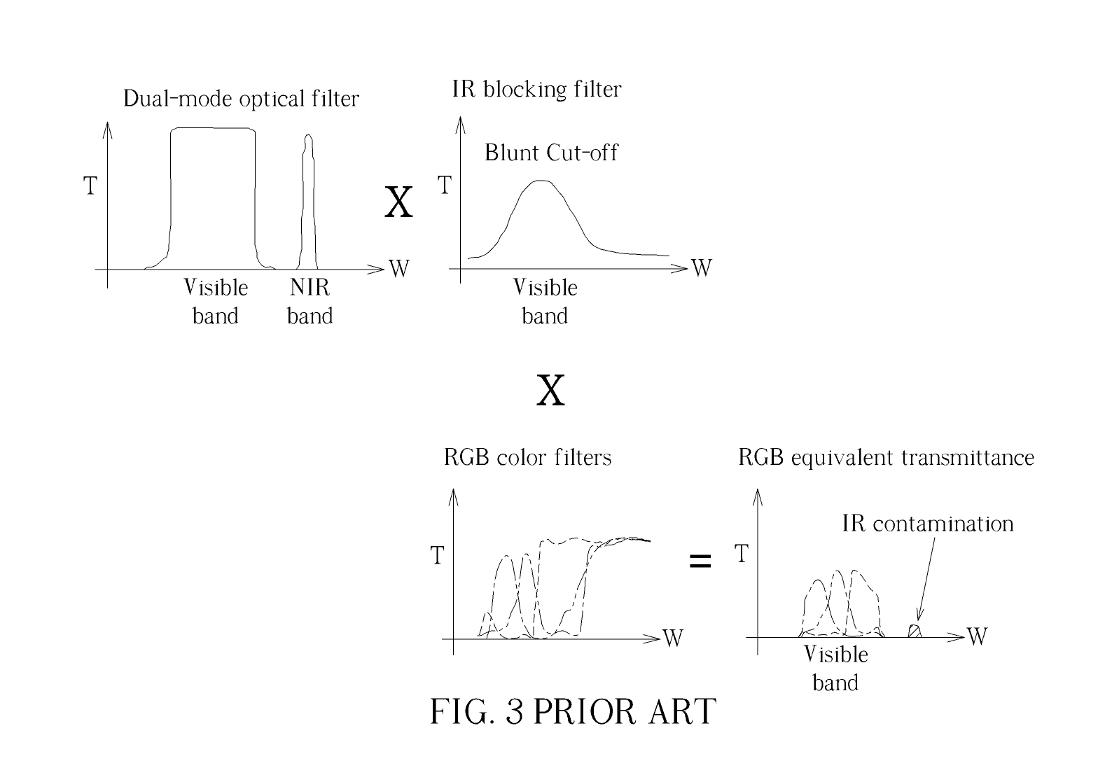

FIG. 4 is a simplified diagram of an imaging system for sensing a 3D image in accordance with an embodiment of the present invention.

FIG. 5 is a simplified diagram of an image sensor of the imaging system in FIG. 4 in accordance with an embodiment of the present invention.

FIG. 6 is a simplified diagram of charts illustrating transmission spectrums of the elements in the imaging system in accordance with an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

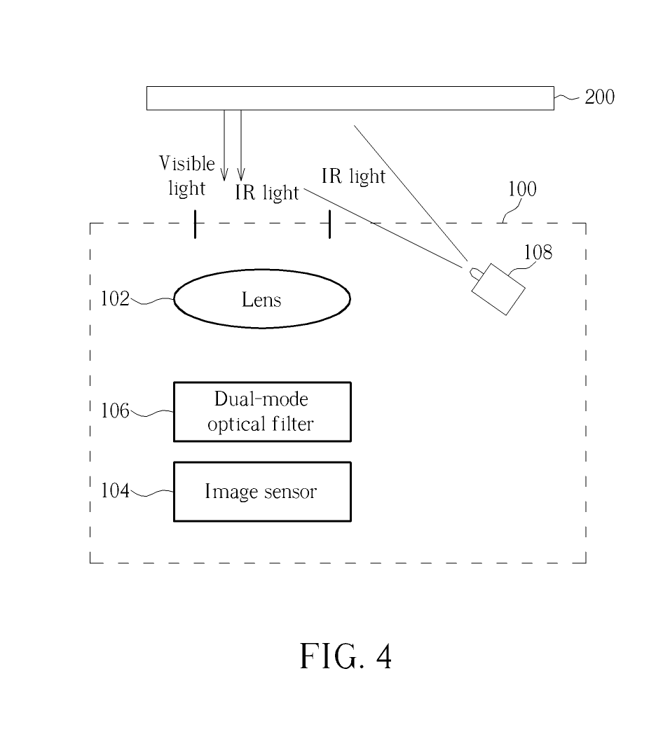

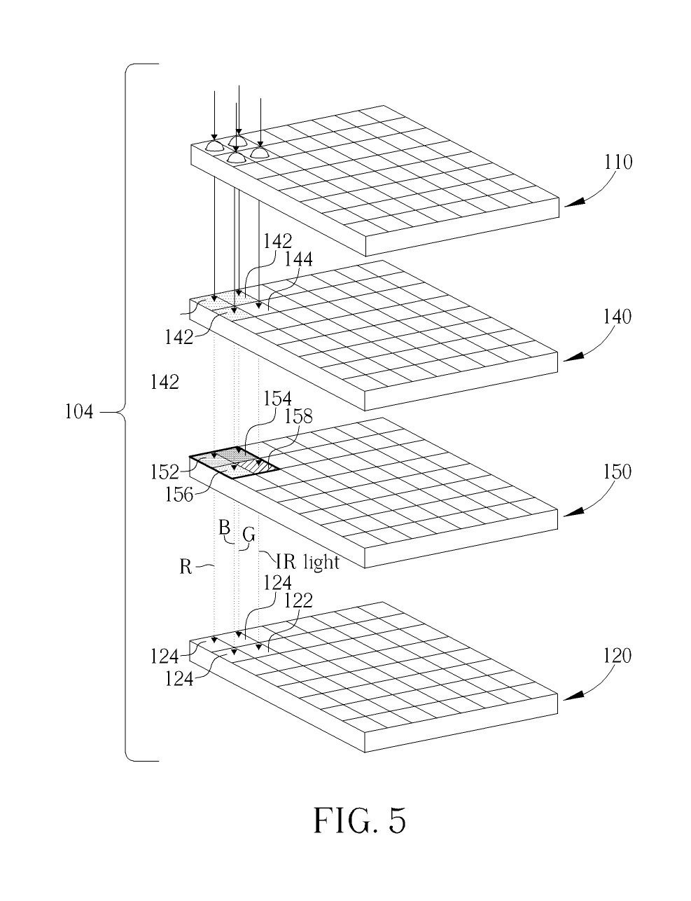

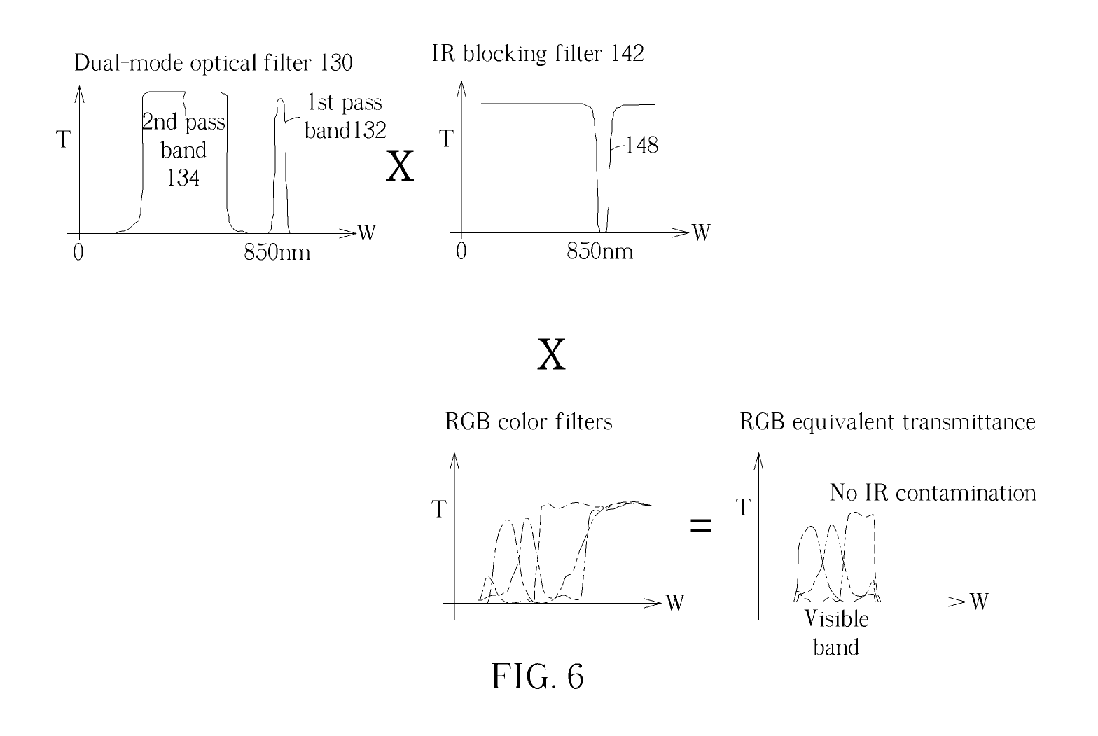

Please refer to FIG. 4, FIG. 5, and FIG. 6. FIG. 4 is a simplified diagram of an imaging system 100 for sensing a 3D image in accordance with an embodiment of the present invention. FIG. 5 is a simplified diagram of an image sensor of the imaging system 100 in accordance with an embodiment of the present invention. FIG. 6 is a simplified diagram of charts illustrating transmission spectrums of the elements in the imaging system 100 in accordance with an embodiment of the present invention. As shown in FIG. 4 and FIG. 5, the imaging system 100 comprises: a lens 102, an image sensor 104, a dual-mode optical filter 106, and an IR light emitter 108. The dual-mode optical filter 106 is disposed between the lens 102 and the image sensor 104, and has a dual window transmission spectrum (shown in FIG. 6) comprising: a first pass band 132 to pass the IR light; and a second pass band 134 to pass the visible light both onto the image sensor 104, wherein the dual-mode optical filter 106 blocks the IR light outside of the first pass band 132, and the first pass band 132 is non-overlapping with the second pass band 134. In addition, the first pass band 132 may be approximately centered within an absorption band of the IR light in Earth's atmosphere and has a width equal to or less than the absorption band of the IR light in the Earth's atmosphere, wherein the first pass band 132 overlaps 850 nm and the width of the first pass band 132 is approximately 50 nm. The lens 102 is utilized for receiving a visible light and an IR light (or a NIR light) reflected by an object 200 and emitted from the IR light emitter 108. The image sensor 104 may be a RGB-IR sensor which is a charge-coupled device (CCD) sensor or a complimentary metal-oxide semiconductor (CMOS) sensor. The image sensor 104 comprises: a micro-lens array 110, a pixel array 120, an IR filter array 140, and a color filter array 150. The pixel array 120 has a first group of pixels 122 and a second group of pixels 124. The micro-lens array 110 is utilized for focusing the visible light and the IR light onto the associated pixels. The IR filter array 140 is disposed between the micro-lens array 110 and the pixel array 120, and comprises: a group of IR blocking filters 142 for mostly blocking the IR light to prevent the IR light from reaching the second group of pixels 124 (As shown in FIG. 6, the IR blocking filter 142 has a stop band 148 corresponding to the first pass band 132 to mostly block the IR light and prevent the IR light from reaching the second group of pixels 124, wherein the stop band 148 may have a notch curve coincident with the first pass band 132 of the dual-mode optical filter 106 to mostly block the IR light and prevent the IR light from reaching the second group of pixels 124); and a group of IR passing filters for passing the IR light to the first group of pixels 122.

As shown in FIG. 6, the IR blocking filter 142 has a stop band 148 corresponding to the first pass band 132 to mostly block the IR light and prevent the IR light from reaching the second group of pixels 124, wherein the stop band 148 may have a notch curve coincident with the first pass band 132 to mostly block the IR light and prevent the IR light from reaching the second group of pixels 124. The color filter array 150 may comprise a group of red color filters 152, a group of green color filters 154, a group of blue color filters 156, and a group of IR passing filter 158. In this way, the second group of pixels 124 will only sense the visible light (e.g. RGB) with highly reduced any IR contamination, and the first group of pixels 122 will only sense the IR light. In addition, the IR light emitter 108 has a spectra band overlapped with the stop band 148 so that the second group of pixels 124 will get least response to the projected IR patterns, and the first group of pixels 122 will suffer less interference from the ambient (i.e. the light energy outside the target IR band). In other words, the imaging system 100 disclosed by the present invention is capable of making the pixel array 120 of the image sensor 104 (i.e. the RGB-IR sensor) to independently sense the visible light (e.g. RGB) and the IR light, and sense the visible light with highly reduced IR contamination. Please note that the above example is only for an illustrative purpose and is not meant to be a limitation of the present invention. For example, the optical elements of the imaging system 100 depicted in FIG. 4 may be changed to be arranged in other suitable order according to different design requirements, and the imaging system 100 also may include other optics than those shown in FIG. 4. In addition, in another embodiment, the imaging system 100 may further contain an exposure control unit coupled to the pixel array 120 to expose the first group of pixels 122 in a given first exposure time and to expose the second group of pixels 124 in a given second exposure time; and a readout circuitry to read-out signals from the first group of pixels 122 and the second group of pixels 124 at the end the exposure pixel exposure durations. Moreover, in another embodiment, the said readout circuitry of the imaging system 100 may contain an analog signal processing unit with two sets of amplifiers respectively for the first group of pixels 122 and the second group of pixels 124; and a shared Analog-to-Digital Converter (ADC) to convert the amplified signals into digital data. In another embodiment, imaging system 100 may further contain a processor comprising an auto-exposure (AE) statistics unit to calculate a first mean ratio based on the RGB image data and a given RGB mean target and a second mean ratio based on the IR image data and a given IR mean target; and an integration (INTG) and Gain control unit to compute a first set of INTG and Gain commands based on the first mean ratio for controlling the first group pixels and a second set of INTG and Gain commands based on the second mean ratio for controlling the second group pixels.

Briefly summarized, the imaging system disclosed by the present invention is capable of making the visible pixels to sense the visible light (e.g. RGB) with highly reduced IR contamination, and the IR pixels will only sense the IR light. In other words, the imaging system disclosed by the present invention is capable of making the pixel array of the image sensor (e.g. the RGB-IR sensor) to independently sense the visible light (e.g. RGB) and the IR light, and sense the visible light with highly reduced IR contamination to improve the color image quality (IQ).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An imaging system for sensing a 3D image, the imaging system comprising:
a lens, for receiving a visible light and an infrared (IR) light;
an image sensor, comprising:
an pixel array, having a first group of pixels and a second group of pixels;
a micro-lens array, for focusing the visible light and the IR light onto associated pixels; and
an IR filter array, disposed between the micro-lens array and the pixel array, comprising a group of IR blocking filters for blocking the IR light to prevent the IR light from reaching the second group of pixels; and
a dual-mode optical filter, disposed between the lens and the image sensor, having a dual window transmission spectrum comprising: a first pass band to pass the IR light; and a second pass band to pass the visible light both onto the image sensor.

2. The imaging system of claim 1, further comprising a color filter array disposed between the IR blocking filter and the pixel array.

3. The imaging system of claim 1, wherein the dual-mode optical filter blocks the IR light outside of the first pass band.

4. The imaging system of claim 1, wherein the first pass band is non-overlapping with the second pass band.

5. The imaging system of claim 4, wherein the first pass band overlaps 850 nm and the width of the first pass band is approximately 50 nm.

6. The imaging system of claim 4, wherein each of the IR blocking filters has a stop band corresponding to the first pass band of the dual-mode optical filter to mostly block the IR light to prevent the IR light from reaching the second group of pixels.

7. The imaging system of claim 6, wherein the stop band has a notch curve coincident with the first pass band of the dual-mode optical filter to mostly block the IR light to prevent the IR light from reaching the second group of pixels.

8. The imaging system of claim 6, further comprising:
an IR light emitter, having a spectra band overlapped with the stop band, for generating the IR light.

9. The imaging system of claim 1, wherein the IR blocking filter array further comprises a group of IR passing filters for passing the IR light to the first group of pixels.
